(19) United States
(12) Patent Application Publication
(10) Pub. No.: US 2026/0350752 A1
(43) Pub. Date: Nov. 5, 2026

(54) Efficient Image Processing Using Denoising Diffusion Models in Latent Texture Spaces

(71) Applicant: Google LLC, Mountain View, CA (US)

(72) Inventors: Prabhu Kaliamoorthi, Mountain View, CA (US); Chen Song, Mountain View, CA (US); Hrishikesh Deepak Garud, San Francisco, CA (US)

(21) Appl. No.: 19/196,293

(22) Filed: May 1, 2025

(51) Int. Cl. G06T 5/60; G06T 3/4046; G06T 3/4053; G06T 5/50; G06T 5/70; G06T 5/73; G06T 5/77

(52) U.S. Cl. CPC G06T 5/60; G06T 3/4046; G06T 3/4053; G06T 5/50; G06T 5/70; G06T 5/73; G06T 5/77; G06T 2207/20081; G06T 2207/20084

(57) ABSTRACT

The present disclosure provides systems and methods for the generation of images using denoising diffusion models, where the denoising diffusion model is configured to operate (e.g., perform denoising) in a latent space that corresponds to texture imagery.

### FIELD

The present disclosure relates generally to machine learning. More particularly, the present disclosure relates to image processing using denoising diffusion models in latent texture spaces.

### BACKGROUND

In the field of digital image processing, various challenges like poor resolution, noise, and blurriness often reduce the quality of photos taken by digital cameras, especially in less-than-ideal conditions such as low light or fast movement. Modern devices are in need of quick and effective image enhancement capabilities. On one hand, traditional methods for fixing or improving these images often struggle to do so efficiently without losing detail, particularly on devices with limited processing power like smartphones and augmented reality devices. On the other hand, new emerging methods often do not target mobile devices and become impossible to deploy due to memory constraints or impractical to execute due to the device's battery.

### SUMMARY

Aspects and advantages of embodiments of the present disclosure will be set forth in part in the following description, or can be learned from the description, or can be learned through practice of the embodiments.

One aspect of the present disclosure is directed to a computer-implemented method for training a denoising diffusion model. The method can include receiving, by a computing system comprising one or more processors, an input image and decomposing, by the computing system, the input image into a texture image and a reduced-size version of the input image. The method can also include compressing, by the computing system, the texture image using an encoder portion of an autoencoder to obtain a latent space representation of the texture image and performing, by the computing system, conditional diffusion with the denoising diffusion model on a noised texture latent using the reduced-size version of the input image as an input condition. The method can further include obtaining, by the computing system, a denoised texture latent as an output of the denoising diffusion model based on the conditional diffusion and training, by the computing system, the denoising diffusion model using the denoised texture latent and the latent space representation of the texture image.

Another aspect of the present disclosure is directed to a computer-implemented method of generating an image. The method can include obtaining, by a computing system, an input image and performing, by the computing system, conditional diffusion with a denoising diffusion model on a noised texture latent using the input image or a reduced-size version of the input image as an input condition, wherein performing the conditional diffusion results in a denoised texture latent.

The method can also include generating, by the computing system, an output image from the denoised texture latent generated as a result of the conditional diffusion, the output image being a modified version of the input image.

A further aspect of the present disclosure is directed to one or more non-transitory computer-readable media that collectively store instructions that, when executed by one or more processors of a computing system, cause the computing system to perform operations. The operations can include obtaining an input image; generating a noisy texture latent expressed in a latent space associated with an autoencoder model that has been trained to encode and decode texture images and processing the noisy texture latent with a machine-learned denoising diffusion model to generate a denoised texture latent, wherein during the processing, the machine-learned denoising diffusion model is conditioned upon the input image or data derived therefrom. The operations can also include decoding the denoised texture latent with a decoder model of the autoencoder model to generate an output texture image.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates a block diagram of an example denoising diffusion model according to example embodiments of the present disclosure.

FIG. 2 illustrates an example autoencoder system comprising an encoder network and a decoder network according to example embodiments of the present disclosure.

FIG. 3 illustrates an example denoising diffusion model according to example embodiments of the present disclosure.

FIG. 4 illustrates an example trained diffusion model in action according to example embodiments of the present disclosure.

FIG. 5 illustrates a flow chart for an example method of training a denoising diffusion model according to example embodiments of the present disclosure.

FIG. 6 illustrates a flow chart for an example method for generating an output image using a denoising diffusion model according to example embodiments of the present disclosure.

FIGS. 7A, 7B, and 7C illustrate block diagrams of example computing systems configured to perform denoising diffusion according to example embodiments of the present disclosure.

### DETAILED DESCRIPTION

Example aspects of the present disclosure are directed to the generation of images using denoising diffusion models, where the denoising diffusion model is configured to operate (e.g., perform denoising) in a latent space that corresponds to texture imagery. In particular, an input image can be decomposed into a texture image and a lower-resolution version of the input image (e.g., a “thumbnail”). The lower-resolution version of the input image can be used as an input condition for conditional diffusion within a latent space associated with the texture image, with the goal of generating a modified version of the input image using conditional diffusion. For example, the proposed process can be performed to generate an output image according to a number of different applications, such as super-resolution, deblurring, denoising, and/or other image processing tasks.

Diffusion models are capable of solving image quality problems introduced by low light or other physical constraints of a camera, such as blur or other noise. Diffusion models solve these problems by inferring details when the details are noisy or missing. However, current implementations of diffusion models in this context are not very computationally efficient, as reconstructing desired images requires a large amount of computing power. This makes performing the diffusion process especially inefficient on computing devices with limited computing power, such as smartphones, virtual reality or augmented reality devices, and the like.

In order to overcome this large computing power requirement, it can be advantageous to rely on a conditioning image as an input into a diffusion model that operates in a latent texture space. By providing one or more conditioning images as input into the diffusion model, the diffusion process can be directed to reconstructing the one or more conditioning images. Furthermore, as will be described in more detail below, because texture imagery, such as stone texture on a wall or a water surface, has relatively lower entropy as compared to standard image space, the diffusion model is able to operate more efficiently (e.g., a fewer number of denoising iterations are necessary to perform to achieve a comparable result).

Thus, systems and methods of the present disclosure can provide a conditioned diffusion process that is significantly more efficient than other forms of diffusion, such as text-conditioned diffusion. In particular, because example implementations of the present disclosure provide a more efficient diffusion process, especially for mobile devices, the usually-large amount of computing power needed to perform the diffusion process can be reduced, thus preserving computing power, battery power needed to power the mobile device, and memory usage on a mobile device or other computing device that may have limited capabilities.

One aspect of the present disclosure is directed to a computer-implemented method for training a denoising diffusion model. The training can occur over multiple (e.g., two) stages. For example, in a first stage, an autoencoder model (e.g., a model including both an encoder model and a decoder model) can be trained so that the autoencoder learns to encode and then decode (e.g., reconstruct) texture images, or images that have been pre-processed to only represent textures from a given input image. As a result, the autoencoder can learn to transform texture images from a pixel space to a texture-based latent space that encodes information about texture images.

In a second stage, a denoising diffusion model can be trained to perform denoising within the texture-based latent space. For example, the denoising diffusion model can be trained to (iteratively) remove noise from a latent texture representation within the texture-based latent space. After training, some or all of these model components can be used to perform various image processing applications such as super-resolution, deblurring, denoising, etc.

More particularly, a computing system can receive an input image. In some cases, the input image can be an image that includes one or more flaws, such as poor lighting conditions, blur introduced by camera movement, or other noise artifacts in the image. In other cases, the input image may simply be a training image and may not include flaw(s).

According to another aspect, the computing system can decompose the input image into a texture image and a reduced-size version of the input image (e.g., which may also be referred to as a “thumbnail”). The texture image can be a visual representation of textures in the input image, such as a grayscale image that illustrates depth, contours, and/or other textural characteristics of the image. In one example, the texture image can include the fine details and textures of the input image, such as highlighting fine details, patterns, and microstructures present in the image to capture surface characteristics and visual elements that contribute to the tactile perception of the image while omitting the broader, low-frequency structural information. The reduced-size version of the input image can be a representation of the input image that includes a smaller number of pixels (e.g., has less resolution) than the original version of the input image. In one example, the reduced-size version of the input image can retain the primary structure and overall shape of features in the input image but at a lower resolution.

As one example, the texture image can have a higher resolution than the reduced-size version of the input image. For example, the texture image can have a 1080p resolution (e.g., 1920 pixels by 1080 pixels), while the reduced-size version of the input image can have a 480p resolution (e.g., 854 pixels by 480 pixels). As another example, the texture image can have the same resolution as the input image. For example, if the input image has a 1080p resolution, the texture image can also have a 1080p resolution while only representing the textures present in the input image.

As another example, decomposing the image into the texture image can include decomposing the input image using a difference of Gaussian algorithm. A difference of Gaussian algorithm is an algorithm that involves subtracting a blurred version of an original image from a less blurred version of the original image. The blurred images can be obtained by using a Gaussian kernel to convolve the original image, which can suppress high-frequency spatial information. Subtracting one image from another can preserve spatial information that lies between the range of frequencies that are preserved in the blurred images. For example, given an input image of a person that includes poor lighting conditions, a difference of Gaussian algorithm can be applied to generate a series of more-blurred versions of the input image while increasing the visibility of edges and other textures from the input image. The difference of Gaussian algorithms can also remove high frequency details, such as random noise, from the input image. For example, in an already-blurred input image, the use of the difference of Gaussian algorithm can remove the random noise, or the blur, from the input image, leaving only edges and other texture information from the input image. In another example, the difference of Gaussian algorithms can detect edges by identifying zero crossings in a second derivative of image intensity.

The use of the difference of Gaussian algorithm offers computational efficiency over other techniques, as the Gaussian blur can be separated into horizontal and vertical components and applied sequentially. This separation of the components can reduce the computational complexity of the image analysis

As another example, the decomposing of the input image can be performed in a spatial domain. Decomposing an input image in a spatial domain analyzes the image at a pixel level to extract image components such as edges, smooth areas, and other textures. For example, decomposing an input image of a person that is blurred allows the computing system to analyze individual pixel information using image pyramids, wavelet transformations, filtering methods, or other techniques.

The image pyramid technique can involve iteratively blurring and downsampling the input image to create a Gaussian pyramid, resulting in a series of images at progressively lower resolutions. The lowest-resolution image can represent the textures, such as edges, of the input image. A Laplacian pyramid can then be constructed by subtracting each level of the Gaussian pyramid from the next higher resolution level image, capturing texture details at each scale.

The wavelet transformation technique can involve decomposing the image into different frequency bands using wavelet filters. A low-frequency band can capture the overall structure of an image, while a high-frequency band can capture texture details. The input image can be reconstructed by combining these bands.

Filtering methods can include using high-pass and low-pass filters on the input image. A low-pass filter, such as a Gaussian blur filter, can be applied to the input image to obtain a smoothed version of the input image that represents the reduced-size image with the main structural content of the input image. The high-pass filter, such as a Laplacian filter, can be applied to the input image to extract high-frequency texture details.

According to another aspect of the present disclosure, the computing system can compress the texture image using an encoder portion of an autoencoder to obtain a latent space representation of the texture image. The low entropy in texture images makes the use of an autoencoder more efficient by reducing computational complexity in the encoding process and can result in high-resolution input and output without tiling effects being present in the texture image.

As one example, the autoencoder can be a variational autoencoder. A variational autoencoder can be a deep learning model that has learned to construct a continuous or discrete latent space where each vector (or embedding) within the space encodes is a representation of an image and contains sufficient information to reconstruct it. Under the framework of variational inference, the autoencoder can be used to generate new realistic data samples, which is useful for reconstructing noisy areas of input images. The aforementioned latent vectors or embeddings created by the encoder of the autoencoder can be a latent space representation of the texture image, or a “texture latent,” which can be a compressed, encoded version of a texture pattern, where key features of the texture like frequency, direction, and variation are captured in a lower-dimension space. This allows for efficient manipulation and generation of new textures based on the encoded information. In one example, the latent space associated with the texture image and a latent space associated with the reduced-size version of the input image can be disjoint, or not overlapping and having no intersection.

According to another aspect of the present disclosure, the computing system can decompress the latent space representation of the texture image using the decoder model of the autoencoder to obtain a reconstruction of the original texture image. The autoencoder model can be trained using a loss function that compares the original texture image with the reconstruction of the original texture image. In such fashion, the autoencoder model can learn to compress texture images into the latent texture space and to decompress latent space representations back out into texture images.

According to another aspect of the present disclosure, to train a denoising diffusion model within the latent texture space, the computing system can perform conditional diffusion with a denoising diffusion model on a noised texture latent using the reduced-size version of the input image as an input condition. The denoising diffusion model can learn to generate data (e.g., by predicting noise to be removed from an input). During training, a number of training iterations are undertaken, where random noise is slowly added to data. The denoising diffusion model then learns to reverse the diffusion process to construct desired data from noise by starting from a noised texture latent, or a random sampling of noise representing an image texture and iteratively denoising the noised texture latent into a denoised texture latent which can be decoded to generate an output image. In one example, the noised texture latent can be generated by adding one or more sets of noise to the latent space representation of the texture image. For example, given a latent space representation of the texture image, the computing system can iteratively add sets of noise to the latent space representation of the texture image to create the noised texture latent. This helps to enforce the texture of the input image as an initial starting point for denoising diffusion.

In another example, performing conditional diffusion can include encoding the reduced-size version of the input image using a separate encoding network and applying the reduced-size version of the input image as an input for conditional diffusion using a cross-attention layer of the denoising diffusion model. To use the reduced-size version of the input image as a conditional input, a latent representation of the reduced-size version of the input image can be obtained by encoding the reduced-size version of the input image. For example, a suitable encoder for encoding the reduced-size version of the input image can be selected to ensure that the relevant features of the reduced-size version of the input image are encoded. This latent representation of the reduced-size version of the input image can then be applied as input through a cross-attention layer of the denoised diffusion model to the denoising diffusion process. For example, to apply the latent representation of the reduced-size version of the input image via a cross-attention layer, the latent representation of the reduced-size version of the input image is applied to the denoising diffusion model by weighting value vectors at the current stage of denoised diffusion based on the latent representation of the reduced-size version of the input image. This weighting of value vectors modifies how the noised texture latent is diffused based on the weights obtained from the latent representation of the reduced-size version of the input image.

Performing conditional diffusion on the latent space representation of the texture image can reduce the denoising diffusion model complexity due to the application of the condition, which guides diffusion and therefore can exclude certain calculations that would be necessary if no condition is present, therefore reducing the model capacity and computational complexity when compared to performing the diffusion without the condition.

According to another aspect of the present disclosure, a denoised texture latent can be obtained as an output of the denoising diffusion model based on the conditional diffusion. The denoised texture latent can be, for example, a latent representation that has successfully been denoised.

The denoising diffusion model can be trained using a loss function that compares the original latent texture representation to the denoised texture representation. For example, training of the denoising diffusion model can include a forward diffusion process to add noise to an original latent texture representation. The denoising diffusion model can then attempt to remove the added noise and create the denoised texture latent. The loss function can evaluate the ability of the denoising diffusion model to successfully remove the added noise. By training on such a loss function, the denoising diffusion model can iteratively learn to remove noise from a noisy input to construct a denoised latent representation that corresponds to texture imagery from a distribution of training data.

Thus, the denoising diffusion model can be trained using the denoised texture latent and a latent space representation of the texture image. In one example, the input image and the denoised texture can be processed using a suitable loss function, such as a KL divergence loss function or another suitable loss function. The output of the loss function can indicate how accurate the conditioned denoising diffusion was based on the input image. Using this loss output of the loss function, the denoising diffusion model can be trained based on the loss output, such as by adjusting weights, values, connections, or the like in the denoising diffusion model.

Furthermore, the computing system can generate an output image based on the input image, a latent space representation of a texture image, and the reduced-size version of the input image. For example, the trained denoising diffusion model can perform conditional diffusion on a noisy texture latent (conditioned upon a conditioning input or data derived therefrom, such as a texture image related to the input image) to generate a denoised texture latent. The decoder model of the trained autoencoder model can then decode the denoised texture latent to obtain a predicted texture image. The predicted texture image and the reduced-size version of the input image can be combined to generate an output image. The output image can demonstrate various characteristics such as increased resolution, reduced blur, reduced noise, alternative content, etc. For example, given an input image of a person that was blurred, the denoised texture latent can be an output image of the person that no longer has blur.

In particular, another aspect of the present disclosure is directed to a computer-implemented method of generating an output image. More particularly, a computing system can receive an input image. In one example, the input image can include one or more noise-induced artifacts, such as blur, poor resolution, poor lighting conditions, and the like.

Another aspect of the present disclosure can include decomposing, by the computing system, the input image into a texture image and a reduced-size version of the input image. the computing system can decompose the input image into a texture image and a reduced-size version of the input image. The texture image can be a visual representation of textures in the input image, such as a grayscale image that illustrates depth, contours, and the like of the image. In one example, the texture image can include the fine details and textures of the input image, such as highlighting fine details, patterns, and microstructures present in the image to capture surface characteristics and visual elements that contribute to the tactile perception of the image while omitting the broader, low-frequency structural information. The reduced-size version of the input image can be a “thumbnail” image, or a representation of the input image that includes fewer pixels (e.g., has less resolution) than the input image. In one example, the reduced-size version of the input image can retain the primary structure and overall shape of features in the input image but at a lower resolution.

As one example, the texture image can have a higher resolution than the reduced-size version of the input image. For example, the texture image can have a 1080p resolution (1920 pixels by 1080 pixels), while the reduced-size version of the input image can have a 480p resolution (854 pixels by 480 pixels). As another example, the texture image can have the same resolution as the input image. For example, if the input image has a 1080p resolution, the texture image can also have a 1080p resolution while only representing the textures present in the input image.

As another example, decomposing the image into the texture image can include decomposing the input image using a difference of Gaussian algorithm or other decomposition algorithms as described above.

According to another aspect, the computing system can perform conditional diffusion with the denoising diffusion model on a noised texture latent using the reduced-size version of the input image as an input condition. The denoising diffusion model can construct desired data from noise by starting from a noised texture latent, or a random sampling of noise representing an image texture and iteratively denoising the noised texture latent into a denoised texture latent which can, in turn, be used to generate an output image. For example, the output image can be generated by decoding the denoised texture latent with a decoder model to generate a predicted texture image and then combining the predicted texture image with other information such as an original input image or some version thereof such as an upscaled version of the lower-resolution version of the input image. In one example, the noised texture latent can be generated by adding one or more sets of noise to the latent space representation of the texture image. For example, given a latent space representation of the texture image, the computing system can iteratively add sets of noise to the latent space representation of the texture image to create the noised texture latent. This helps to enforce the texture of the input image as an initial starting point for denoising diffusion.

In another example, performing conditional diffusion can include encoding the reduced-size version of the input image using a separate encoding network and applying the reduced-size version of the input image as an input for conditional diffusion using a cross-attention layer of the denoising diffusion model. To use the reduced-size version of the input image as a conditional input, a latent representation of the reduced-size version of the input image can be obtained by encoding the reduced-size version of the input image. For example, a suitable encoder for encoding the reduced-size version of the input image can be selected to ensure that the relevant features of the reduced-size version of the input image are encoded. This latent representation of the reduced-size version of the input image can then be applied via a cross-attention layer of the denoised diffusion model to the denoising diffusion process. For example, to apply the latent representation of the reduced-size version of the input image via a cross-attention layer, the latent representation of the reduced-size version of the input image is applied to the denoising diffusion by weighting value vectors at the current stage of denoised diffusion based on the latent representation of the reduced-size version of the input image. This weighting of value vectors modifies how the noised texture latent is diffused based on the weights obtained from the latent representation of the reduced-size version of the input image.

In one example, performing conditional diffusion can include a plurality of denoising iterations. Using multiple iterations of denoising can allow the denoising diffusion model to iteratively remove sets of noise from the noised texture latent. In one example, the denoised texture latent obtained as an output of a first denoising iteration can then be used as the starting point, or used as the “noised” texture latent, for a second subsequent denoising iteration. Using the output of each iteration of denoising as the initial noised texture latent in a subsequent iteration allows the denoising diffusion model to remove noise in a step-by-step fashion so that important details from each iteration are not lost as they are denoised.

Performing conditional diffusion on the latent space representation of the texture image can reduce the denoising diffusion model complexity due to the application of the condition, which guides diffusion and therefore can exclude certain calculations that would be necessary if no condition is present.

According to another aspect of the present disclosure, a denoised texture latent can be obtained as an output of the denoising diffusion model based on the conditional diffusion. The denoised texture latent can be used to generate an output image that is generated based on the input image, the latent space representation of the texture image, and the reduced-size version of the input image. As one example, the denoised texture latent can be used to generate a modified version of the input image. In one example, the denoised texture latent can be decoded by the autoencoder to a pixel space to generate a predicted texture image. The predicted texture image can be recomposed with the reduced-size version of the input image to create a final output image that recreates the structure and the features of the input image while undesirable noise and texture(s) have been removed by the diffusion process. For example, given an input image of a person that was blurred, the final output image can be an output image of the person that no longer has blur. In another example, the output image can be a denoised version of the input image. In a further example, the output image can be an increased-resolution version of the input image, or a “super-resolution” version of the input image.

The systems and methods of the can be used in a number of different applications or use cases.

As one example, the systems and methods described herein can be used to remove poor lighting conditions from an input image. For example, given an input image that includes lens flare, lack of lighting, or other complexities, the proposed systems and methods can generate an output image that removes these deficiencies, resulting in an output image with proper lighting and any lighting artifacts removed.

As another example, the systems and methods described herein can be used to generate a super-resolution, or increased-resolution, version of the input image. If an input image has poor resolution, or if a user of the system wishes to create a higher-resolution version of the image, the proposed systems and methods can generate such an output that can introduce additional resolution into the image, such as by adding pixels and modifying pixel values to increase the resolution of the image.

As a further example, the systems and methods described herein can be used to generate a deblurred version of an input image. The input image can include blur, or a noise artifact caused by movement of the camera taking the image, especially in low lighting conditions, due to the shutter speed of the image. The proposed systems and methods can remove blur from images by identifying textures in the image and generating an output that includes the relevant features and textures of the image without the high-noise blur.

As yet another example, the systems and methods described herein can be used to remove other noise artifacts from an input image. Noise artifacts are any irregularities in an image that do not originate from original scene content. Noise artifacts can include poor representation of features, a grainy structure covering an image, and the like. The proposed systems and methods can take a noisy image as an input and generate a denoised output that removes the noise artifacts while maintaining the texture and structures in the image.

As another example, the systems and methods described herein can be used in image inpainting or outpainting. Image inpainting can involve adding new objects to images or correcting blurry portions of images by generating new portions that do not have blur that are consistent with other portions of the image. Image outpainting can involve generating novel portions of images that are “outside” the input image that are consistent with areas at the periphery of input images, such as adding additional landscape details and the like. The proposed systems and methods can add these portions to images based on the inpainting or outpainting requirements while maintaining image texture integrity by using the image texture to enforce the textures in the image while adding the requirements through a second input condition.

Thus, the proposed systems and methods can generate modified versions of input images that can remove flaws or increase the resolution of the input image while keeping the texture and structures of the input image intact. Furthermore, the proposed systems and methods can perform these actions while reducing the computational complexity of the denoising process using latent representations of textures as a starting point for diffusion and using a reduced-size version of the input image as a condition, resulting in reducing the amount of computing power, memory, and/or network bandwidth needed to perform the denoising process. Specifically, thumbnail conditioned diffusion is significantly more efficient than text conditioned diffusion as done in typical latent diffusion models because the thumbnail is a strong predictor of texture. This allows image quality problems to be solved in a very efficient manner. The reduction in need for computing power, memory, and/or network bandwidth makes the deployment of the proposed systems and methods advantageous over existing solutions, especially on mobile computing devices and other computing devices that may have limited computing capabilities.

Furthermore, performing diffusion in the texture-based latent space significantly enhances computational efficiency by leveraging the intrinsic properties of texture images, which generally exhibit lower entropy compared to full-resolution images. This lower entropy characteristic means that texture images contain less information and variability, allowing for a more streamlined and less computationally intensive encoding and decoding process within the autoencoder model. By focusing the denoising diffusion model's operations within this texture-based latent space, the process inherently requires fewer computational resources. Consequently, this focused approach not only speeds up the diffusion process but also reduces the overall computational load, making it particularly advantageous for applications on devices with limited processing capabilities, such as smartphones and augmented reality devices. This method efficiently preserves or enhances image quality while optimizing the use of computational resources.

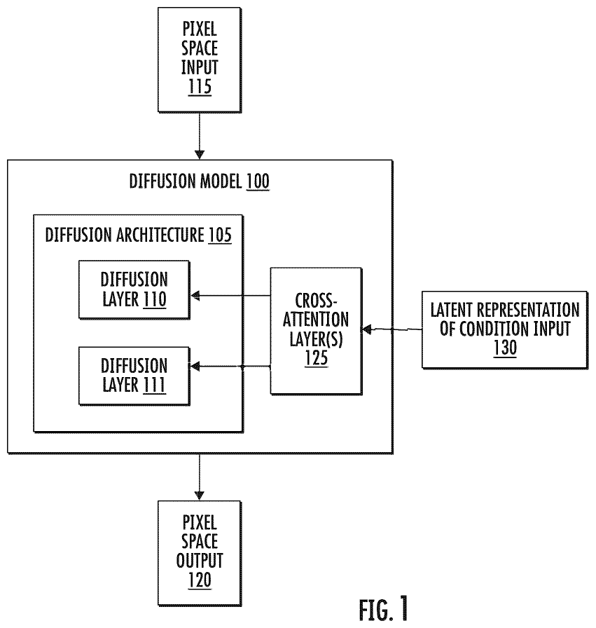

FIG. 1 illustrates a block diagram of a denoising diffusion model 100 according to one aspect of the present disclosure. The denoising diffusion model 100 can include, in some examples, a diffusion architecture 105 that comprises a plurality of diffusion layers 110 and 111. FIG. 1 generally illustrates how the denoising diffusion model 100 can generate an output given an input and one or more conditions. In one embodiment, given a pixel space input 115, the denoising diffusion model 100 can generate a pixel space output 120. For example, given some input image as the pixel space input 115, the denoising diffusion model 100 can generate an output image as the pixel space output 120.

The denoising diffusion model 100 can be trained by first performing forward diffusion on the pixel space input 115 over iterative steps to obtain a pure random Gaussian noise distribution. The denoising diffusion model 100 can then perform reverse diffusion in an attempt to learn how to reconstruct the pixel space input 115 given the pure random Gaussian noise distribution. The denoising diffusion model 100 can iteratively remove noise from the pure random Gaussian noise distribution and compare the output of this removal at each iteration to the pixel space input 115. This comparison can be performed using one or more suitable loss functions, such as a Kullback-Liebler (“KL”) divergence. Based on the comparison, the denoising diffusion model 100 can iteratively learn how to reconstruct the pixel space input 115.

The diffusion architecture 105 can be any suitable architecture for a diffusion model, such as a variational autoencoder architecture or any other architecture that includes both an encoder and decoder. The diffusion architecture 105 can include a plurality of different diffusion layers, such as diffusion layers 110 and 111, that can encode and/or decode data. In one example, the diffusion architecture 105 can receive a pixel space input, such as random Gaussian noise with first dimensions, pixel space input 115, or a combination of the two. The diffusion architecture 105 can encode the received pixel space input into a latent space representation of the pixel space input, or latent variable representations of the pixel space input that inform how the data that makes up the pixel space input is distributed.

An encoder portion of the diffusion architecture 105 can compress the latent space representation of the pixel space input into a lower-dimensional space that captures the information contained in the original input. In one example, the diffusion layer 110 can be an encoder portion of the diffusion architecture 105 that takes as input a pixel space input, such as an image, and encodes the pixel space input into a latent representation of the input.

A decoder portion of the diffusion architecture 105 can attempt to reconstruct, or decode, the original input based on the latent representation of the input. Using the latent variables identified by encoding the input, the decoder portion of the diffusion architecture 105 can attempt to reconstruct the original input based on the relevant latent variables while discarding irrelevant noise from the input. In one example, the diffusion layer 111 can be a decoder portion of the diffusion architecture 105 that takes as input a latent space representation of the input and reconstructs a pixel space output in an attempt to approximate the original pixel space input.

During training, the diffusion architecture 105 performs both encoding and decoding and then can compare the original input to the output of the decoder portion of the diffusion architecture 105. After each training iteration, optimization algorithms can be used, such as gradient descent, to adjust weights, parameters, and/or variables within the encoder and decoder portions of the diffusion architecture 105 with the goal of minimizing the difference between the original input and the output of the decoder portion. The eventual goal of training the diffusion architecture 105 is for the encoder portion to learn what information is most conducive to accurate reconstruction and the decoder portion to learn to reconstruct the original input given this information.

After training, the diffusion architecture 105 can take an input, such as the pixel space input 115, and generate a pixel space output 120 that accurately reconstructs the pixel space input 115.

In some embodiments, the denoising diffusion model can also include one or more cross-attention layers 125. Cross-attention layers in denoising diffusion models allow for multiple inputs to be mixed to generate a single output, such as mixing the diffusion process with a condition for diffusion. For example, an encoded latent space representation of an input condition 130 can be applied to the diffusion process via one or more of the cross-attention layers 125 by, for example, performing matrix multiplication of the latent representation of the input condition 130 at one or more of the plurality of the diffusion layers 110 and 111. This matrix multiplication alters the values at the one or more of the plurality of the diffusion layers 110 and 111 to “enforce” the condition upon different stages of the encoding and decoding process. This causes the encoding of the input and/or the decoding of the latent representation of the input to adhere more to the latent representation of the input condition 130, causing a more directed output to be generated. For example, given a latent representation of an image as an input condition, the denoising diffusion model 100 can generate an image with structure matching the structure of the image used as the input condition.

Thus, based on one or more conditions and a given input, the denoising diffusion model 100 can learn to reconstruct the given input given the conditions. After training, the denoising diffusional model 100 can, in some embodiments, construct an output from random Gaussian noise combined with the pixel space input 115 based on any input conditions, such as input condition 130.

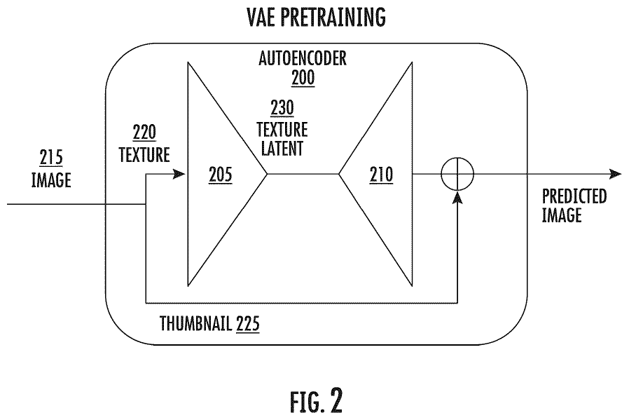

FIG. 2 is a block diagram illustrating an autoencoder 200 according to one aspect of the present disclosure. The autoencoder 200 can include an encoder network 205 and a decoder network 210.

The autoencoder 200 can be a deep learning model that learns to isolate important latent variables from data and a decoder that uses the latent variables to reconstruct the input data. In some embodiments, the autoencoder 200 can be a variational autoencoder. A variational autoencoder can encode a continuous, probabilistic representation of the latent space that contains the latent variables, instead of encoding a discrete, fixed representation of the latent space. This allows a variational autoencoder to not only accurately reconstruct an exact representation of the original input but also use variational inference to generate new data samples that resemble the original input data. For example, the variational autoencoder can encode latent variables of input data not as a fixed discrete value (e.g., z), but instead as a continuous range of possibilities expressed as a probability distribution, such as p(z|x), where z is a particular latent variable and x is a value of observable variables. For each attribute in the input data, the variational autoencoder can encode two latent representations: a vector of means and a vector of standard deviations. By randomly sampling from within this range of encoded possibilities, the variational autoencoder can synthesize new data samples that resemble the original input data.

In some implementations, the autoencoder 200 can be a conditional variational autoencoder. Conditional variational autoencoders can generate outputs conditioned by specific inputs, rather than solely generating variations of training data at random. This can be achieved by incorporating supervised or semi-supervised learning during training of the autoencoder 200 rather than utilizing only unsupervised learning. In one example, the autoencoder 200 can be trained on a large set of images with supervised or semi-supervised direction using a latent representation of a texture image, such as a texture image 220 representing textures decomposed from an input image. The texture image 220 can identify portions of images that have similar or same textures, creating an image that provides information about these textures while not identifying other characteristics, such as color or structure of the pixels in the image.

Specifically, the autoencoder 200 can train the encoder network 205 to encode the texture image 220 into a texture latent 230. The texture latent 230 can be a vector representation of the details of the texture image 220 reduced to a lower-dimensionality vector via the encoding process of the encoder network 205, preserving the important details of the texture image 220 while removing unnecessary or unimportant noise from the texture image 220, including removing noise artifacts from the texture image 220. These noise artifacts can include lens flare, poor lighting conditions, image blur, low resolution, and other artifacts.

The autoencoder 200 can be pre-trained separately from the denoising diffusion network. During pre-training of the autoencoder 200, the autoencoder 200 can be provided an input image that comprises a reduced-sized version of the input image 215 and a texture image, such as texture image 220. The texture image 220 can be provided to the encoder network 205, which encodes the texture image 220 into the texture latent 230. The texture latent 230 can then be provided to the decoder network 210, which can decode the texture latent 230 back into a predicted texture image. In some examples, the predicted texture image can be combined with the reduced-size version of the input image 215 to create a predicted image, which can then be compared to the input image. The difference between the predicted image and the input image can then be used to train the autoencoder 200, with the eventual goal of learning how to reduce or eliminate noise artifacts from the input image by decoding noised texture latents.

Using the texture image 220 to generate the texture latent 230 for training is advantageous over encoding and decoding the entire input image. For example, texture images are low in entropy because structure and other details, such as color, are not represented. This makes the encoding process more efficient because the complexity of the image to be encoded is reduced while still being able to handle high-resolution texture images, such as 4k images. The resulting decoding process is then more efficient because the texture latent 230 includes less information than a latent space representation of the input image.

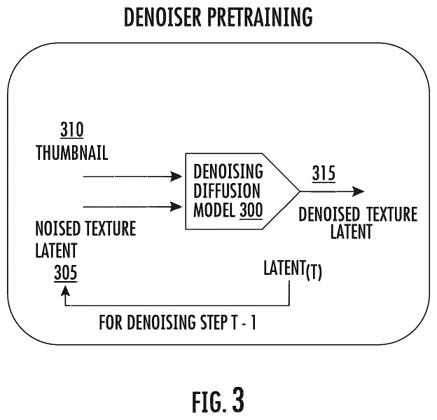

FIG. 3 is a block diagram representing a denoising diffusion model 300 according to one aspect of the present disclosure. The denoising diffusion model 300 can receive a noised texture latent 305 and a reduced-size version of the input image 310. In some embodiments, the denoising diffusion model 300 can include an autoencoder, such as the autoencoder 200 described in FIG. 2.

The noised texture latent 305 can be a texture latent that is generated by adding noise to a texture latent that is encoded by an autoencoder. For example, the texture image can be encoded into a texture latent and then Gaussian noise can be iteratively added by the denoising diffusion model 300 to generate the noised texture latent 305. The denoising diffusion model 300 can then perform diffusion on the noised texture latent 305 to generate a denoised texture latent 315.

In some embodiments, a reduced-size version of the input image 310 can be used as a condition for diffusion. As described above with regards to FIG. 1, a latent representation of the reduced-size version of the input image 310 can be generated and then applied using cross-attention layers as a condition for diffusion. To apply the latent representation of the reduced-size version of the input image 310 using cross-attention layers, the latent representation of the reduced-size version of the input image 310 can be encoded using a second encoding network that is specific to encoding and/or decoding the reduced size version of the input image 310, such as being trained only on reduced-size versions of input images. This second encoding network can output a vector representation of the reduced size version of the input image 310 that can be applied as weights to the diffusion process performed on the noised texture latent 305 via the cross-attention layers of the denoising diffusion model 300. These weights can emphasize particular features in the denoising process to ensure accurate recreation of the original input image (e.g., maintaining color and structure, such as positions of objects within the original input image) while noise artifacts, such as blur, are removed by denoising the noised texture latent 305.

In some embodiments, the denoising diffusion model 300 can perform a plurality of diffusion iterations. After generating the denoised texture latent 315 for a first diffusion iteration, the denoised texture latent 315 can be provided for a second diffusion iteration as the noised texture latent 305. In this way, the denoising diffusion model 300 can iteratively remove noise artifacts while maintaining the structure and color of input images via application of the reduced-size version of the input image 310 in a plurality of steps, creating a more accurate final output.

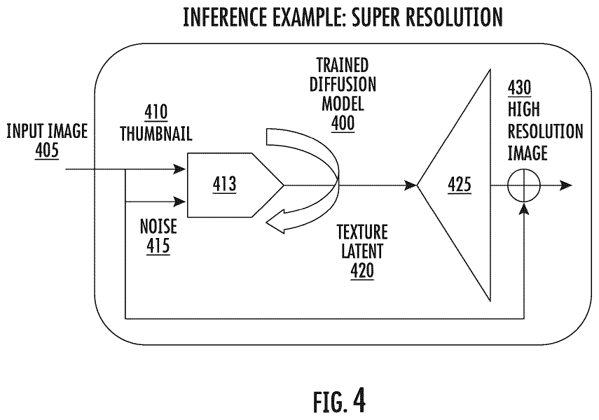

FIG. 4 is a block diagram illustrating an example of inference-time diffusion using a trained diffusion model 400 according to an example aspect of the present disclosure.

The trained diffusion model 400 can be a diffusion model trained according to aspects described with regards to FIGS. 2 and 3. For example, the trained diffusion model 400 can include an encoder 413 and a decoder 425 that have been trained using texture image representations of input images to generate texture latents. In one embodiment, the encoder 413 can be similar to the autoencoder 220 described in FIG. 2.

The input image 405 can be decomposed into a reduced-size version of the input image 410 and, in some embodiments, a texture image representing textures of the input image 405. The reduced-size version of the input image 410 can be, in one embodiment, a thumbnail representation of the input image 405, where the reduced-size version of the input image 410 has a lower resolution than the input image 405. The input image 405 can be a pixel space representation of an image with one or more noise artifacts, such as blur, reduced resolution, and the like.

The reduced-size version of the input image 410 can be encoded using a separate encoding network into a latent representation of the reduced-size version of the input image 410. In some embodiments, the latent representation of the reduced-size version of the input image 410 can be a vector or other encoded representation of the reduced-size version of the input image 410.

The encoder 413 can receive noise 415 and begin encoding the noise 415 into a texture latent 420 by, for example, performing denoising diffusion on the noise 415. In some embodiments, the latent representation of the reduced-size version of the input image 410 can be applied using cross-attention layers of the encoder 413 as a condition for the diffusion process.

The output of the diffusion process is the texture latent 420, which can be a latent representation of a texture image that is conditioned on the reduced-size version of the input image 410. In some embodiments, the encoder can receive the texture latent 420 as a new starting point for a subsequent diffusion step, with the texture latent 420 replacing the noise 415 as the image to be diffused. In this way, the encoder 413 can iteratively diffuse the noise 415 into a texture representation of the input image 405 with noise artifacts removed, such as removing blur or low-resolution areas of the input image 405.

In some embodiments, the encoder 413 can also perform inpainting or outpainting based on a second input condition. In these embodiments, a text input or other input, such as an input image of a particular object, can be provided as an input condition to the diffusion process. This second input condition can be encoded using a separate encoding network to obtain a latent representation of the second input condition, which can then be applied in a similar manner to the reduced-size version of the input image 410 using cross-attention layers to condition the diffusion. In this way, the second input condition can condition the texture diffusion such that the request from the second input condition (e.g., the addition of an object inpainted into the final output image or an extension of the image via outpainting) is present in the resulting texture latent 420.

After the diffusion process is complete, the texture latent 420 (a final texture latent) can be decoded into the pixel space by the decoder 425. The resulting output is a texture image in the pixel space. The texture image can then be combined with the reduced-size version of the input image 410 in the pixel space to create a final output image 430.

In some embodiments, the final output image 430 can be a higher-resolution version of the input image 405. In other embodiments, the final output image 430 can be a version of the input image 405 without noise artifacts, such as being a deblurred version of the input image 405. In further embodiments, the final output image 430 can include an inpainted portion or outpainted portions added by the diffusion process.

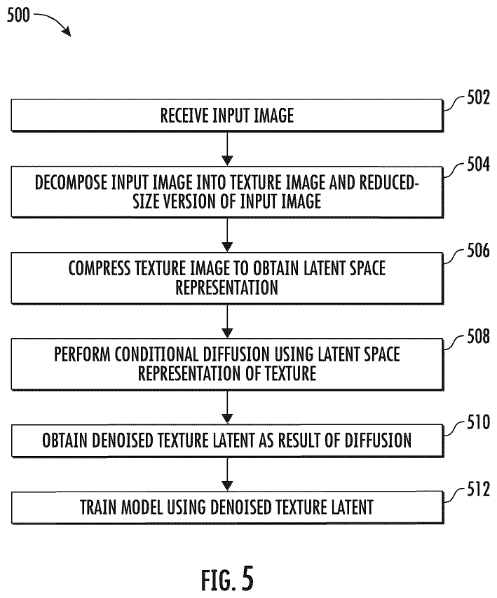

FIG. 5 is a flow chart illustrating a method 500 for training a denoising diffusion model according to an example aspect of the present disclosure.

At block 502, the method 500 can include receiving, by a computing system comprising one or more processors, an input image. The input image can include, in some embodiments, noise artifacts such as blur, low-resolution portions, or the like.

At block 504, the method 500 can include decomposing, by the computing system, the input image into a texture image and a reduced-size version of the input image. In some embodiments, the texture image can be a visual representation of textures in the input image, such as a grayscale image that illustrates depth, contours, and the like of the image. In one example, the texture image can include the fine details and textures of the input image, such as highlighting fine details, patterns, and microstructures present in the image to capture surface characteristics and visual elements that contribute to the tactile perception of the image while omitting the broader, low-frequency structural information. The reduced-size version of the input image can be a “thumbnail” image, or a representation of the input image that includes fewer pixels (e.g., has less resolution) than the input image. In one example, the reduced-size version of the input image can retain the primary structure, colors, and overall shape of features in the input image but at a lower resolution.

As one example, the texture image can have a higher resolution than the reduced-size version of the input image. For example, the texture image can have a 1080p resolution (1920 pixels by 1080 pixels), while the reduced-size version of the input image can have a 480p resolution (854 pixels by 480 pixels). As another example, the texture image can have the same resolution as the input image. For example, if the input image has a 1080p resolution, the texture image can also have a 1080p resolution while only representing the textures present in the input image.

As another example, decomposing the image into the texture image can include decomposing the input image using a difference of Gaussian algorithm.

At block 504, the method 500 can include compressing, by the computing system, the texture image to obtain a latent space representation of the texture image. The lower entropy in texture images relative to images that do not depict textures makes the use of an autoencoder more efficient by reducing computational complexity in the encoding process and can result in high-resolution input and output without tiling effects being present in the texture image. As one example, the autoencoder can be a variational autoencoder. A variational autoencoder can be a deep learning model that has learned to isolate important latent variables and can encode a continuous, probabilistic representation of that latent space, allowing a variational autoencoder to both accurately reconstruct the original input image and use variational inference to generate new data samples that resemble the input data, which is useful for reconstructing noisy areas of input images. The output of the autoencoder can be a latent space representation of the texture image, or a “texture latent,” which can be a compressed, encoded version of a texture pattern, where key features of the texture like frequency, direction, and variation are captured in a lower-dimension space. This allows for efficient manipulation and generation of new textures based on the encoded information. In one example, the latent space associated with the latent space representation of the texture image and a latent space associated with the reduced-size version of the input image can be different from one another.

At block 508, the method 500 can include performing, by the computing system, conditional diffusion using the latent space representation of the texture image. Conditional diffusion can be performed with the denoising diffusion model on a noised texture latent using the reduced-size version of the input image as an input condition. The denoising diffusion model can construct desired data from noise by starting from a noised texture latent, or a random sampling of noise representing an image texture and iteratively diffusing the noised texture latent into an output image. In one example, the noised texture latent can be generated by adding one or more sets of noise to the latent space representation of the texture image. For example, given a latent space representation of the texture image, the computing system can iteratively add sets of noise to the latent space representation of the texture image to create the noised texture latent. This helps to enforce the texture of the input image as an initial starting point for denoising diffusion.

In another example, performing conditional diffusion can include encoding the reduced-size version of the input image using a separate encoding network and applying the reduced-size version of the input image as an input for conditional diffusion using a cross-attention layer of the denoising diffusion model. To use the reduced-size version of the input image as a conditional input, a latent representation of the reduced-size version of the input image can be obtained by encoding the reduced-size version of the input image. For example, a suitable encoder for encoding the reduced-size version of the input image can be selected to ensure that the relevant features of the reduced-size version of the input image are encoded. This latent representation of the reduced-size version of the input image can then be applied via a cross-attention layer of the denoised diffusion model to the denoising diffusion process. For example, to apply the latent representation of the reduced-size version of the input image via a cross-attention layer, the latent representation of the reduced-size version of the input image is applied to the denoising diffusion by weighting value vectors at the current stage of denoised diffusion based on the latent representation of the reduced-size version of the input image. This weighting of value vectors modifies how the noised texture latent is diffused based on the weights obtained from the latent representation of the reduced-size version of the input image.

In one example, performing conditional diffusion can include a plurality of denoising iterations. Using multiple iterations of denoising can allow the denoising diffusion model to iteratively remove sets of noise from the noised texture latent. In one example, the denoised texture latent obtained as an output of a first denoising iteration can then be used as the starting point, or used as the “noised” texture latent, for a second subsequent denoising iteration. Using the output of each iteration of denoising as the initial noised texture latent in a subsequent iteration allows the denoising diffusion model to remove noise in a step-by-step fashion so that important details from each iteration are not lost as they are denoised.

Performing conditional diffusion on the latent space representation of the texture image can reduce the denoising diffusion model complexity due to the application of the condition, which guides diffusion and therefore can exclude certain calculations that would be necessary if no condition is present.

At block 510, the method 500 can include obtaining, by the computing system, a denoised texture latent as an output of the denoising diffusion model based on the conditional diffusion. The denoised texture latent can be, for example, an output image that is generated based on the input image, the latent space representation of the texture image, and the reduced-size version of the input image. As one example, the denoised texture latent can be a modified version of the input image. In one example, the denoised texture latent can be decoded by the autoencoder to a pixel space and recomposed with the reduced-size version of the input image to create a final output image that recreates the structure and the features of the input image while undesirable noise and texture(s) have been removed by the diffusion process. For example, given an input image of a person that was blurred, the final output image can be an output image of the person that no longer has blur. In another example, the output image can be a denoised version of the input image. In a further example, the output image can be an increased-resolution version of the input image, or a “super-resolution” version of the input image.

At block 512, the method 500 can include training, by the computing system, the denoising diffusion model using the denoised texture latent. For example, the input image and the denoised texture latent can be processed using a loss function and, based on the loss from the loss function, one or more features, weights, parameters, or the like of the denoising diffusion model can be modified.

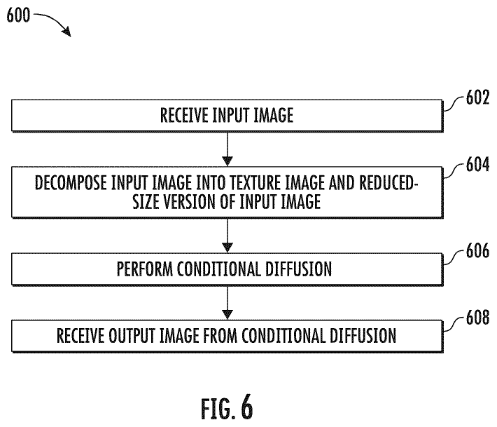

FIG. 6 is a flow chart that represents a method 600 of generating, using a computing system comprising one or more processors, an image according to example aspects of the present disclosure.

At block 602, the method 600 can include receiving, by the computing system, an input image. The input image can include, in some embodiments, noise artifacts such as blur, low-resolution portions, or the like.

At block 604, the method 600 can include decomposing the input image into a texture image and a reduced-size version of the input image. In some embodiments, the texture image can be a visual representation of textures in the input image, such as a grayscale image that illustrates depth, contours, and the like of the image. In one example, the texture image can include the fine details and textures of the input image, such as highlighting fine details, patterns, and microstructures present in the image to capture surface characteristics and visual elements that contribute to the tactile perception of the image while omitting the broader, low-frequency structural information. The reduced-size version of the input image can be a “thumbnail” image, or a representation of the input image that includes fewer pixels (e.g., has less resolution) than the input image. In one example, the reduced-size version of the input image can retain the primary structure, colors, and overall shape of features in the input image but at a lower resolution.

As one example, the texture image can have a higher resolution than the reduced-size version of the input image. For example, the texture image can have a 1080p resolution (1920 pixels by 1080 pixels), while the reduced-size version of the input image can have a 480p resolution (854 pixels by 480 pixels). As another example, the texture image can have the same resolution as the input image. For example, if the input image has a 1080p resolution, the texture image can also have a 1080p resolution while only representing the textures present in the input image.

As another example, decomposing the image into the texture image can include decomposing the input image using a difference of Gaussian algorithm.

At block 606, the method 600 can include performing conditional diffusion with a denoising diffusion model on a noised texture latent using the reduced-size version of the input image as an input condition. An encoder portion of the denoising diffusion model can receive noise and begin encoding the noise into a texture latent by, for example, performing denoising diffusion on the noise 415. In some embodiments, the latent representation of the reduced-size version of the input image can be applied using cross-attention layers of the encoder as a condition for the diffusion process.

The output of the diffusion process is the texture latent, which can be a latent representation of a texture image that is conditioned on the reduced-size version of the input image. In some embodiments, the encoder can receive the texture latent as a new starting point for a subsequent diffusion step, with the texture latent replacing the noise as the image to be diffused. In this way, the encoder can iteratively diffuse the noise into a texture representation of the input image with noise artifacts removed, such as removing blur or low-resolution areas of the input image.

At block 612, the method 600 can include receiving an output image from the conditional diffusion.

After the diffusion process is complete, the texture latent (a final texture latent) can be decoded into the pixel space by a decoder portion of the denoising diffusion model. The resulting output is a texture image in the pixel space. The texture image can then be combined with the reduced-size version of the input image in the pixel space to create a final output image.

In some embodiments, the final output image can be a higher-resolution version of the input image. In other embodiments, the final output image can be a version of the input image without noise artifacts, such as being a deblurred version of the input image. In further embodiments, the final output image can include an inpainted portion or outpainted portions added by the diffusion process.

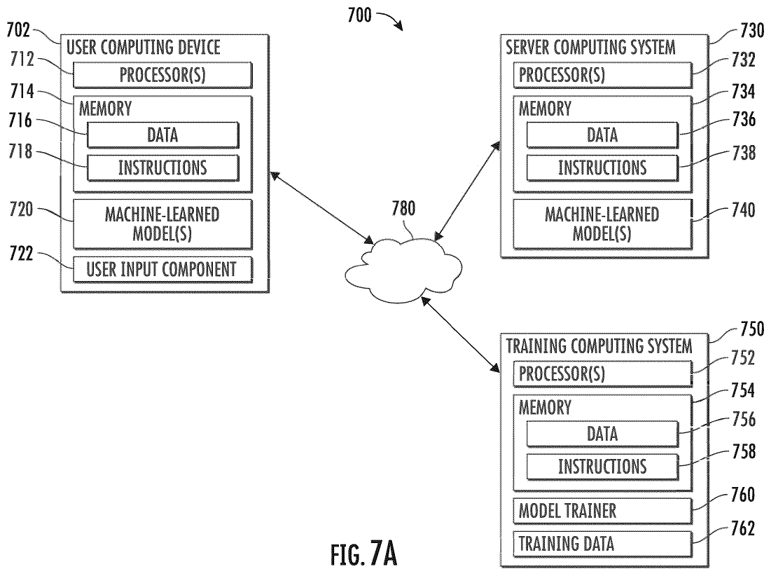

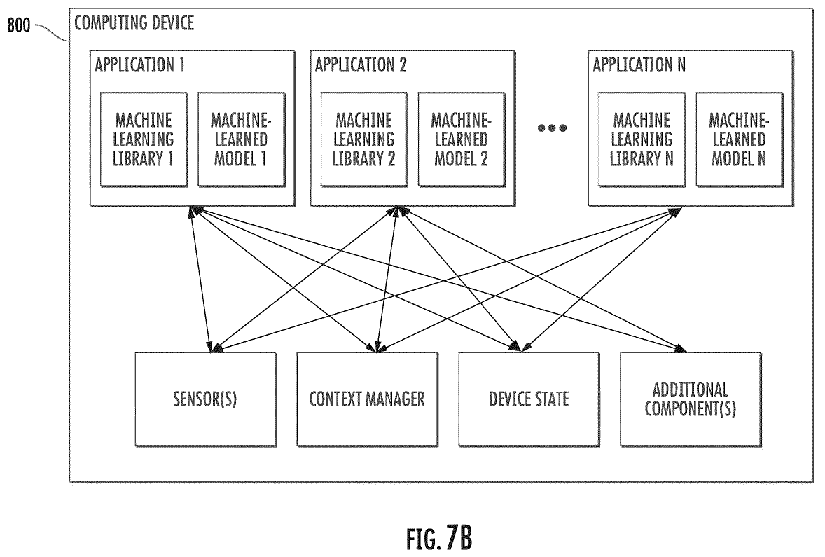

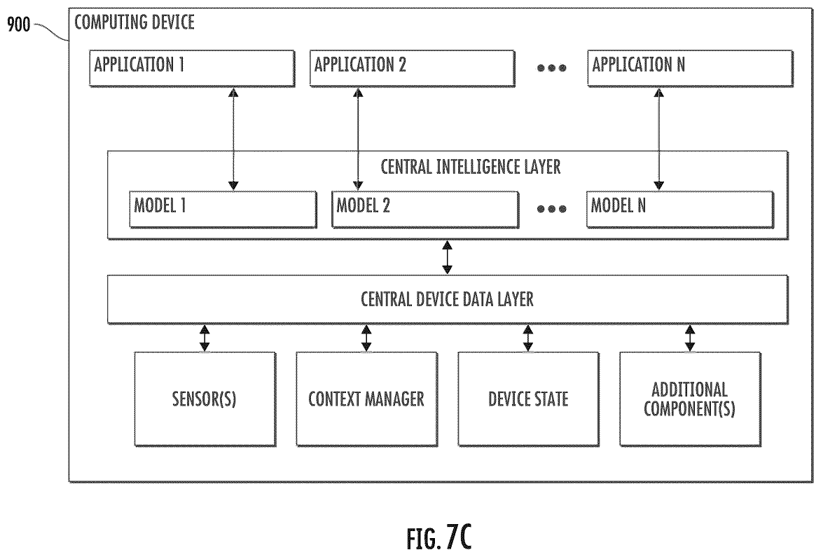

FIG. 7A depicts a block diagram of an example computing system 700 that performs denoising diffusion according to example embodiments of the present disclosure. The system 700 includes a user computing device 702, a server computing system 730, and a training computing system 750 that are communicatively coupled over a network 780.

The user computing device 702 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 702 includes one or more processors 712 and a memory 714. The one or more processors 712 can be any suitable processing device (e.g., a processor core, a microprocessor, an ASIC, an FPGA, a controller, a microcontroller, etc.) and can be one processor or a plurality of processors that are operatively connected. The memory 714 can include one or more non-transitory computer-readable storage media, such as RAM, ROM, EEPROM, EPROM, flash memory devices, magnetic disks, etc., and combinations thereof. The memory 714 can store data 716 and instructions 718 which are executed by the processor 712 to cause the user computing device 702 to perform operations.

In some implementations, the user computing device 702 can store or include one or more denoising diffusion models 720. For example, the denoising diffusion models 720 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example denoising diffusion models 720 are discussed with reference to FIGS. 1-4.

In some implementations, the one or more denoising diffusion models 720 can be received from the server computing system 730 over network 780, stored in the user computing device memory 714, and then used or otherwise implemented by the one or more processors 712. In some implementations, the user computing device 702 can implement multiple parallel instances of a single denoising diffusion model 720 (e.g., to perform parallel diffusion across multiple instances of diffusion).

More particularly, based on one or more conditions and a given input, the denoising diffusion model 720 can learn to reconstruct the given input given the conditions. After training, the denoising diffusional model 720 can, in some embodiments, then construct an output from random Gaussian noise combined with the pixel space input based on any input conditions, such as a reduced-size version of the input image.

Additionally or alternatively, one or more denoising diffusion models 740 can be included in or otherwise stored and implemented by the server computing system 730 that communicates with the user computing device 702 according to a client-server relationship. For example, the denoising diffusion models 740 can be implemented by the server computing system 730 as a portion of a web service (e.g., a denoising diffusion service). Thus, one or more models 720 can be stored and implemented at the user computing device 702 and/or one or more models 740 can be stored and implemented at the server computing system 730.

The user computing device 702 can also include one or more user input components 722 that receives user input. For example, the user input component 722 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 730 includes one or more processors 732 and a memory 734. The one or more processors 732 can be any suitable processing device (e.g., a processor core, a microprocessor, an ASIC, an FPGA, a controller, a microcontroller, etc.) and can be one processor or a plurality of processors that are operatively connected. The memory 734 can include one or more non-transitory computer-readable storage media, such as RAM, ROM, EEPROM, EPROM, flash memory devices, magnetic disks, etc., and combinations thereof. The memory 734 can store data 736 and instructions 738 which are executed by the processor 732 to cause the server computing system 730 to perform operations.

In some implementations, the server computing system 730 includes or is otherwise implemented by one or more server computing devices. In instances in which the server computing system 730 includes plural server computing devices, such server computing devices can operate according to sequential computing architectures, parallel computing architectures, or some combination thereof.

As described above, the server computing system 730 can store or otherwise include one or more denoising diffusion models 740. For example, the models 740 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 740 are discussed with reference to FIGS. 1-4.

The user computing device 702 and/or the server computing system 730 can train the models 720 and/or 740 via interaction with the training computing system 750 that is communicatively coupled over the network 780. The training computing system 750 can be separate from the server computing system 730 or can be a portion of the server computing system 730.

The training computing system 750 includes one or more processors 752 and a memory 754. The one or more processors 752 can be any suitable processing device (e.g., a processor core, a microprocessor, an ASIC, an FPGA, a controller, a microcontroller, etc.) and can be one processor or a plurality of processors that are operatively connected. The memory 754 can include one or more non-transitory computer-readable storage media, such as RAM, ROM, EEPROM, EPROM, flash memory devices, magnetic disks, etc., and combinations thereof. The memory 754 can store data 756 and instructions 758 which are executed by the processor 752 to cause the training computing system 750 to perform operations. In some implementations, the training computing system 750 includes or is otherwise implemented by one or more server computing devices.

The training computing system 750 can include a model trainer 760 that trains the machine-learned models 720 and/or 740 stored at the user computing device 702 and/or the server computing system 730 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 760 can perform a number of generalization techniques (e.g., weight decays, dropouts, etc.) to improve the generalization capability of the models being trained.

In particular, the model trainer 760 can train the denoising diffusion models 720 and/or 740 based on a set of training data 762. The training data 762 can include, for example, input images that the denoising diffusion models 720 and/or 740 can extract texture latents from and attempt to reproduce.

In some implementations, if the user has provided consent, the training examples can be provided by the user computing device 702. Thus, in such implementations, the model 720 provided to the user computing device 702 can be trained by the training computing system 750 on user-specific data received from the user computing device 702. In some instances, this process can be referred to as personalizing the model.

The model trainer 760 includes computer logic utilized to provide desired functionality. The model trainer 760 can be implemented in hardware, firmware, and/or software controlling a general purpose processor. For example, in some implementations, the model trainer 760 includes program files stored on a storage device, loaded into a memory and executed by one or more processors. In other implementations, the model trainer 760 includes one or more sets of computer-executable instructions that are stored in a tangible computer-readable storage medium such as RAM, hard disk, or optical or magnetic media.

The network 780 can be any type of communications network, such as a local area network (e.g., intranet), wide area network (e.g., Internet), or some combination thereof and can include any number of wired or wireless links. In general, communication over the network 780 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 7A illustrates one example computing system that can be used to implement the present disclosure. Other computing systems can be used as well. For example, in some implementations, the user computing device 702 can include the model trainer 760 and the training dataset 762. In such implementations, the models 720 can be both trained and used locally at the user computing device 702. In some of such implementations, the user computing device 702 can implement the model trainer 760 to personalize the models 720 based on user-specific data.

FIG. 7B depicts a block diagram of an example computing device 800 that performs according to example embodiments of the present disclosure. The computing device 800 can be a user computing device or a server computing device.

The computing device 800 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 7B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 7C depicts a block diagram of an example computing device 900 that performs according to example embodiments of the present disclosure. The computing device 900 can be a user computing device or a server computing device.

The computing device 900 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 7C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 900.

The central intelligence layer can communicate with a central device data layer. The central device data layer can be a centralized repository of data for the computing device 900. As illustrated in FIG. 7C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for training a denoising diffusion model, the method comprising:
receiving, by a computing system comprising one or more processors, an input image;
decomposing, by the computing system, the input image into a texture image and a reduced-size version of the input image;
compressing, by the computing system, the texture image using an encoder portion of an autoencoder to obtain a latent space representation of the texture image;
performing, by the computing system, conditional diffusion with the denoising diffusion model on a noised texture latent using the reduced-size version of the input image as an input condition;
obtaining, by the computing system, a denoised texture latent as an output of the denoising diffusion model based on the conditional diffusion; and
training, by the computing system, the denoising diffusion model using the denoised texture latent and the latent space representation of the texture image.

2. The computer-implemented method of claim 1, wherein the texture image has a higher resolution than the reduced-size version of the input image.

3. The computer-implemented method of claim 1, wherein the texture image has a same resolution as the input image.

4. The computer-implemented method of claim 1, further comprising generating the noised texture latent by adding one or more sets of noise to the latent space representation of the texture image.

5. The computer-implemented method of claim 1, wherein the autoencoder is a variational autoencoder.

6. The computer-implemented method of claim 1, wherein training the denoising diffusion model comprises:
processing, by the computing system, the input image and the denoised texture latent using a loss function; and
training, by the computing system, the denoising diffusion model based on a loss obtained from the loss function.

7. The computer-implemented method of claim 1, wherein the denoised texture latent comprises a modified version of the input image.

8. The computer-implemented method of claim 1, wherein decomposing the input image into the texture image comprises decomposing the image using a difference of Gaussian algorithm.

9. The computer-implemented method of claim 1, wherein performing conditional diffusion comprises:
encoding, by the computing system, the reduced-size version of the input image using a separate encoding network; and
applying, by the computing system, the reduced-size version of the input image as an input for the conditional diffusion using a cross-attention layer of the denoising diffusion model.

10. The computer-implemented method of claim 1, wherein a latent space associated with the latent space representation of the texture image and a latent space associated with the reduced-size version of the input image are disjoint.

11. The computer-implemented method of claim 1, wherein the decomposing of the input image is performed in a spatial domain.

12. A computer-implemented method of generating an image, the method comprising:
obtaining, by a computing system, an input image;
performing, by the computing system, conditional diffusion with a denoising diffusion model on a noised texture latent using the input image or a reduced-size version of the input image as an input condition, wherein performing the conditional diffusion results in a denoised texture latent; and
generating, by the computing system, an output image from the denoised texture latent generated as a result of the conditional diffusion, the output image being a modified version of the input image.

13. The computer-implemented method of claim 12, wherein generating, by the computing system, the output image from the denoised texture latent comprises processing, by the computing system, the denoised texture latent with a machine-learned decoding model to generate a higher-resolution version of the input image.

14. The computer-implemented method of claim 12, wherein the output image comprises an improved version of the input image.

15. The computer-implemented method of claim 12, wherein performing conditional diffusion comprises:
encoding, by the computing system, the input condition using a separate encoding network; and
applying, by the computing system, the input condition as an input for the conditional diffusion using a cross-attention layer of the denoising diffusion model.

16. The computer-implemented method of claim 12, wherein performing conditional diffusion comprises a plurality of denoising iterations, and wherein the denoised texture latent obtained as an output of a first denoising iteration of the plurality of denoising iterations, the computer-implemented method further comprising:
performing, by the computing system, a second denoising iteration subsequent to the first denoising iteration, wherein the denoised texture latent is used as the noised texture latent for the second denoising iteration.

17. The computer-implemented method of claim 12, wherein the output image is a denoised version of the input image.

18. The computer-implemented method of claim 12, wherein the output image is a deblurred version of the input image.

19. The computer-implemented method of claim 12, wherein the output image comprises an inpainted or outpainted version of the input image.

20. One or more non-transitory computer-readable media that collectively store instructions that, when executed by one or more processors of a computing system, cause the computing system to perform operations, the operations comprising:
obtaining an input image; generating a noisy texture latent expressed in a latent space associated with an autoencoder model that has been trained to encode and decode texture images;
processing the noisy texture latent with a machine-learned denoising diffusion model to generate a denoised texture latent, wherein during the processing, the machine-learned denoising diffusion model is conditioned upon the input image or data derived therefrom; and
decoding the denoised texture latent with a decoder model of the autoencoder model to generate an output texture image.
